(19) United States
(12) Patent Application Publication
(10) Pub. No.: US 2018/0180145 A1
(43) Pub. Date: Jun. 28, 2018

(54) SPINDLE DRIVE AND AN ACTUATOR COMPRISING A SPINDLE DRIVE

(71) Applicant: ZF Friedrichshafen AG, Friedrichshafen (DE)

(72) Inventors: Henning SCHWENKE, Osnabrück (DE); Stefan SCHMIDT, Osnabrück (DE); Frank BRINKMANN, Vechta (DE)

(21) Appl. No.: 15/739,211

(22) PCT Filed: May 30, 2016
(86) PCT No.: PCT/EP2016/062106

§ 371 Date: Dec. 22, 2017

(30) Foreign Application Priority Data
Jul. 2, 2015 (DE) 10 2015 212 448.7

(51) Int. Cl. F16H 25/24

(52) U.S. Cl. CPC F16H 25/24; B62D 5/0445

(57) ABSTRACT

A spindle drive (1) having a spindle (2) with a spindle thread (2a), and spindle nut (3) with a nut thread (3a). The spindle thread (2a) and the nut thread (3a) form a movement thread (4) having a crown clearance (5), a root clearance (6) and a flank clearance. The spindle (2) and the spindle nut (3) can be centered by virtue of a reduced crown clearance (5) and/or a reduced root clearance (6).

This application is a National Stage completion of PCT/EP2016/062106 filed May 30, 2016, which claims priority from German patent application serial no. 10 2015 212 448.7 filed Jul. 2, 2015.

### FIELD OF THE INVENTION

The invention concerns a spindle drive comprising a spindle with a spindle thread and a spindle nut with a nut thread, and an actuator with a spindle drive.

### BACKGROUND OF THE INVENTION

Spindle drives are known and are used for a variety of purposes, for example as servo-motors with a self-locking movement thread, which can be a trapezoidal, rectangular or saw-tooth thread. Trapezoidal threads have a crown and root clearance and a flank clearance; they are designed for axial loads and should not be loaded with transverse forces. In the case of trapezoidal threads, the spindle is centered relative to the spindle nut by means of the flanks, which is therefore referred to as flank centering. However, if transverse forces occur, which result in a misalignment of the spindle axis and the nut axis, the flanks of the spindle and nut threads become jammed and this results in sticking and increased resistance, i.e. a larger drive torque is needed and indeed the spindle drive can fail. To avoid this it is known to provided a round centering outside the movement thread, but this takes up more space in the axial direction and incurs higher costs.

It is also known to use spindle drives in actuators, also called servo-motors. In the older application by the present Applicant with file number 10 2014 206 934.3 an actuator with a spindle drive for a rear wheel steering system of a motor vehicle was described. In that application the spindle is not only loaded by axial forces but is also subjected to bending stresses due to which transverse forces can occur in the movement threads of the spindle drive. The result of this is that in some circumstances the spindle and the spindle nut can no longer be coaxial, so that the function of the spindle drive would be at least restricted.

### SUMMARY OF THE INVENTION

The problem addressed by the present invention is solved by the independent claims. Advantageous design features emerge from the subordinate claims.

According to a first aspect of the invention, in a spindle drive it is provided that the spindle and the spindle nut can be centered by virtue of a reduced crown and/or root clearance. In contrast with the known and standardized movement threads, the movement thread has either a reduced crown clearance or a reduced root clearance, or both a reduced crown clearance and a reduced root clearance. By virtue of the reduced crown and/or root clearance, flank centering as in the known trapezoidal threads is excluded, but rather, the centering takes place due to a reduced radial clearance between the threads of the spindle and the nut. Sticking or jamming can no longer take place, since due to centering by virtue of corresponding crown and root circles, concentricity is ensured.

According to a preferred embodiment, the movement thread is in the form of a trapezoidal thread, i.e. the invention starts from a known and standardized trapezoidal thread (DIN 103), which is modified in such manner that it has a reduced crown and/or root clearance. The trapezoidal thread has a symmetrical thread cross-section and can therefore be loaded equally in both axial directions.

In a further preferred embodiment, the crown and/or the root clearance is in the form of a sliding or displacement fit. The tolerance between corresponding crown and root diameters must therefore be designed such that sliding can always take place between the circumferential surfaces of the spindle and the nut.

According to another preferred embodiment, the nut thread has a smaller root circle diameter, i.e. compared with the root circle diameter of the known trapezoidal thread the root circle diameter of the nut thread according to the invention is made sufficiently smaller for the crown clearance to be reduced to a minimum. Compared with the standardized trapezoidal thread, the crown circle diameter of the spindle thread remains unchanged. Likewise, the root clearance remains unchanged. This embodiment form has particular production technology advantages, namely when cutting the nut thread.

In a further preferred embodiment, the spindle thread has an enlarged crown circle diameter, whereas compared with the standard thread the root circle diameter of the nut thread remains unchanged. This also results in a reduced crown or radial clearance and a spindle with a larger outer diameter.

Preferably, the nut thread has a smaller crown circle diameter, i.e. compared with the crown circle diameter of the known trapezoidal thread, the crown circle diameter of the nut thread is made sufficiently small for the root clearance to be reduced to a minimum. Compared with the standardized trapezoidal thread, the root circle diameter of the spindle thread remains unchanged.

In a preferred embodiment, the spindle thread has an enlarged root circle diameter, whereas compared with the standardized thread the crown circle diameter of the nut thread remains unchanged. This also results in reduced root or radial clearance and a spindle with a larger root circle diameter.

According to another preferred embodiment, the crown and/or root clearance is respectively smaller than the radial fraction of the flank clearance. Thus, if transverse forces occur during the operation of the spindle drive, which impair the concentricity, i.e. which result in a displacement of the spindle and nut axes, then the radial clearance first becomes zero while at the same time there remains an axial clearance greater than zero. This avoids sticking of the movement thread.

In a further preferred embodiment, between the crown circle surface and the flanks a first transition contour, and between the root circle surface and the flanks a second transition contour are provided, between which a gap is left. This prevents any sticking or wear of the material at the rotating corner areas of the movement thread.

According to another preferred embodiment, the transition contours are made with different radii, with the smaller radius in the area of the root circle transition and the larger radius in the area of the crown circle transition.

According to a further preferred embodiment, the transition contours are in the form of chamfers, i.e. oblique edges between which an annular gap is left.

In another preferred embodiment, the spindle thread has cylindrical crown circle surfaces and the nut thread has cylindrical root circle surfaces, which slide over one another in the manner of a slide bearing and thereby bring about the centering. Due to the cylindrical shape, the area is maximized, i.e. the surface pressure is minimized.

According to a further aspect of the invention, the spindle drive according to the invention is used in an actuator, particularly preferably for the rear wheel steering system of motor vehicles. As mentioned at the start regarding the prior art, in such actuators bending stresses occur in the spindle, which can interfere with the concentricity of the spindle and nut threads. Here, the centering according to the invention by virtue of a reduced radial clearance without additional axial fitting space works particularly advantageously, since the functionality of the spindle drive is ensured even if transverse forces occur. Since the rear wheel steering is a safety-relevant system, the advantage of operational safety is particularly important.

### BRIEF DESCRIPTION OF THE DRAWINGS

Example embodiments of the invention are illustrated in the drawing and are described in more detail below, so that further features and/or advantages can emerge from the description and/or the drawing, which show:

FIG. 1: A view of a spindle drive with a reduced crown clearance of the movement thread,

FIG. 2: An enlarged illustration of the reduced crown clearance,

FIG. 2a: A detail X from FIG. 2, with enlarged transition contours (radii),

FIG. 3: A further embodiment for transition contours (chamfers), and

FIG. 4: A further embodiment of the invention for a spindle drive with a reduced root clearance.

### DETAILED DESCRIPTION OF THE PREFERRED EMBODIMENTS

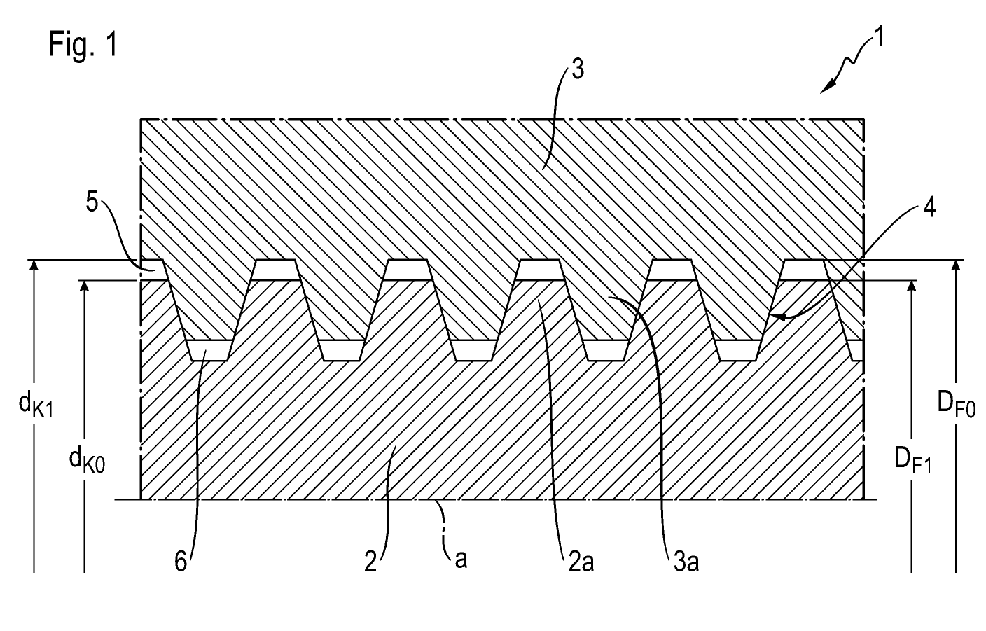

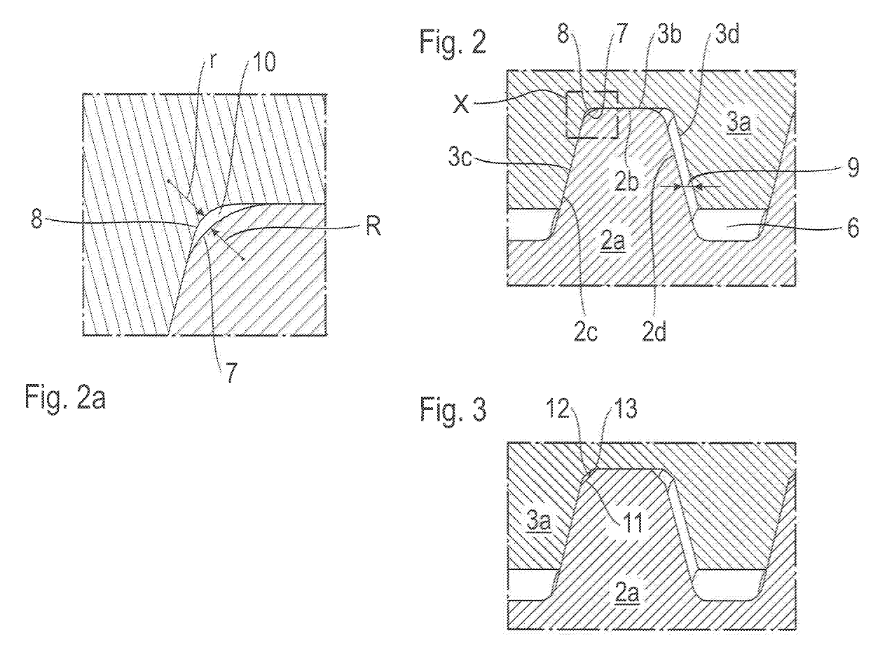

FIG. 1 shows, as a first embodiment of the invention, a section of a spindle drive 1 with a spindle 2 having a spindle thread 2a and a spindle nut 3 having a nut thread 3a and a rotational axis a. The spindle or bolt thread 2a, together with the nut thread 3a, form a movement thread 4 preferably in the form of a trapezoidal thread and which in its geometry derives from a known trapezoidal thread according to DIN 103. Concentricity exists when the axes of the spindle thread 2a and the nut thread 3a coincide with the rotational axis a. The standardized trapezoidal thread has a crown clearance 5 and a root clearance 6, which are also called radial clearances. In addition, the standardized trapezoidal thread has a flank clearance also known as the axial clearance. The standardized trapezoidal thread is flank-centered, i.e. displacement of the thread axes of the spindle and nut threads is absorbed by the flanks so that there is no radial contact between the crown circle of the spindle thread and the root circle of the nut thread. The spindle thread 2a according to the invention has a crown circle diameter d_{K0} that corresponds to the crown circle diameter of the standardized trapezoidal thread. The nut thread 3a has a root circle diameter D_{F1} which is smaller compared with the root circle diameter D_{F0} of the standardized nut thread, i.e. D_{F1}<D_{F0}. Due to the reduction of the root circle diameter of the nut thread 3a, the crown clearance 5 is reduced to a sliding contact, so that the spindle thread 2a by virtue of its crown circle d_{K0} is centered relative to the root circle D_{F1} of the nut thread 3a. If the concentricity between the spindle 2 and the nut 3 is impaired, a radial sliding contact takes place, i.e. the radial clearance becomes practically zero; at the same time, however—as explained below in reference to FIG. 2—a flank clearance also known as axial clearance is still present. The root clearance 6 between the spindle thread 2a and the nut thread 3a corresponds to the root clearance 6 of a standardized trapezoidal thread and is therefore unchanged.

FIG. 2 shows an enlarged view of the reduced crown clearance between the spindle thread 2a and the nut thread 3a. The trapezoidal profile of the spindle thread 2a has a cylindrical crown circle surface 2b and two flanks 2c, 2d, which merge into one another via a first transition contour 7. The trapezoidal profile of the nut thread 3a has a cylindrical root circle surface 3b and two flanks 3c, 3d, which merge into one another via second transition contours 8. As can be seen from the drawing, the crown circle surface 2b is in contact with the root circle surface 3b with no clearance, i.e. there is a sliding contact between the cylindrical surfaces 2b, 3b which form a slide bearing. The known crown clearance of the standard thread is here reduced practically to zero. Preferably, between the cylindrical outer or crown circle surface 2b and the cylindrical inner or root circle surface 3b there is a sliding or displacement fit, by which the minimum and maximum crown clearance are defined.

FIG. 2 further shows an axial clearance 9, also called flank clearance 9, i.e. a distance in the axial direction between the flank 2d of the spindle thread 2a and the flank 3d of the nut thread 3a. From this representation it can be seen that with the reduced crown clearance according to the invention there can be no jamming of the flanks 2d, 3d or 2c, 3c since the radial fraction of the axial clearance 9 is always larger than the radial fraction of the flank clearance. The root clearance 6 already mentioned above can also be seen clearly here.

FIG. 2a shows a detail X from FIG. 2, i.e. the transition contours 7, 8 in an enlarged representation. The two transition contours 7, 8 are formed as radii r, R, wherein the radius r on the nut thread 3a is smaller than the radius R on the spindle thread 2a, so that between the two transition contours 7, 8 there is a circumferential gap 10. This avoids sticking or wear in the corner area.

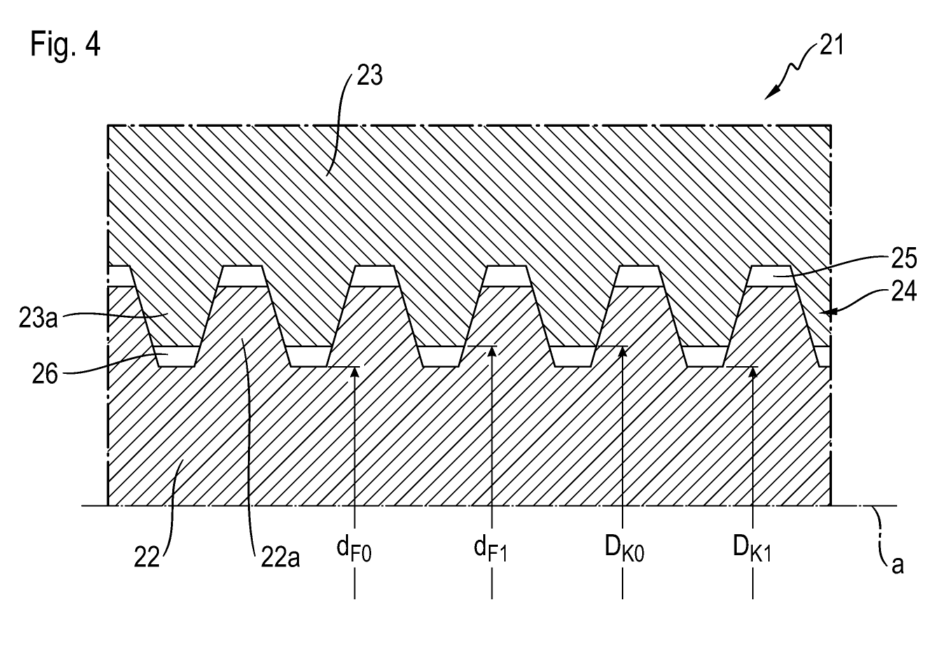

FIG. 3 shows a further embodiment for the transition contours, in this case in the form of a first chamfer 12 on the nut thread 3a and a second chamfer 11 on the spindle thread 2a. Between the two chamfers 11, 12 there is a gap 13.

FIG. 4 shows another embodiment of the invention for a spindle drive 21 having a spindle 22 with a spindle thread 22a, a spindle nut 23 with a nut thread 23a and a rotational axis a. The spindle thread 22a and the nut thread 23a form a movement thread 24 in the form of a trapezoidal thread, which is derived from a standardized trapezoidal thread. The standard thread would have a crown clearance 25 and a root clearance 26, also called radial clearance. In this variant according to the invention the root clearance 26 is reduced, and this indeed preferably to a sliding or displacement fit. The crown clearance 25 is kept the same. Thus, the centering of the spindle 22 relative to the nut 23 takes place by virtue of the reduced root clearance 26, which is preferably produced by the following alternative change to the standard thread. A change is made in the spindle thread, and concerns an enlargement of the root circle diameter d_{F0} of the standard thread to the root circle diameter d_{F1} according to the invention. The crown circle diameter D_{K0} of the nut thread 23a remains unchanged, as also does the crown clearance 25. A further change is made in the nut thread and consists in making the crown circle diameter D_{K0} of the standard thread smaller, reducing it to the crown circle diameter D_{K1}, so that the relationship D_{K1}<D_{K0} applies. Correspondingly, for the first variant d_{F1}>d_{F0} also applies.

A further, more theoretical variant not illustrated in the drawing would be that both the crown clearance and the root clearance are reduced.

### INDEXES

1 Spindle drive
2 Spindle
2a Spindle thread
2b Crown circle surface
2c Flank
2d Flank
3 Spindle nut
3a Nut thread
3b Root circle surface
3c Flank
3d Flank
4 Movement thread
5 Crown clearance
6 Root clearance
7 First transition contour
8 Second transition contour
9 Flank clearance
10 Gap
11 Chamfer
12 Chamfer
13 Gap
21 Spindle drive
22 Spindle
22a Spindle thread
23 Spindle nut
23a Nut thread
24 Movement thread
25 Crown clearance
26 Root clearance
a Rotational axis
d_{K0} Crown circle diameter, spindle (standard)
d_{K1} Crown circle diameter, spindle, enlarged
d_{F0} Root circle diameter, spindle (standard)
d_{F1} Root circle diameter, spindle, enlarged
D_{K0} Crown circle diameter, nut (standard)
D_{K1} Crown circle diameter, nut, reduced
D_{F0} Root circle diameter, nut (standard)
D_{F1} Root circle diameter, nut, reduced
r Radius of transition contour
R Radius of transition contour

1-14. (canceled)

15. A spindle drive comprising:
a spindle (2, 22) with a spindle thread (2a, 22a);
a spindle nut (3, 23) with a nut thread (3a, 23a);
the spindle thread (2a, 22a) and the nut thread (3a, 23a) forming a movement thread (4, 24) having a crown clearance (5, 25), a root clearance (6, 26) and a flank clearance (9); and
the spindle (2, 22) and the spindle nut (3, 23) being centered by at least one of a reduced crown clearance (5, 25) and a reduced root clearance (6, 26).

16. The spindle drive according to claim 15, wherein the movement thread is a trapezoidal thread (4, 24).

17. The spindle drive according to claim 15, wherein at least one of the crown clearance (5, 25) and the root clearance (6, 26) is designed as either a sliding fit or a displacement fit (2b, 3b).

18. The spindle drive according to claim 15, wherein the nut thread (3a) has a reduced root circle diameter (D_{F1}).

19. The spindle drive according to claim 15, wherein the spindle thread (2a) has an enlarged crown circle diameter (d_{K1}).

20. The spindle drive according to claim 15, wherein the nut thread (3a) has a reduced crown circle diameter (D_{K1}).

21. The spindle drive according to claim 15, wherein the spindle thread (2a) has an enlarged root circle diameter (d_{F1}).

22. The spindle drive according to claim 15, wherein at least one of the crown clearance (5, 25) and the root clearance (6, 26) is smaller than a radial portion of the flank clearance (9).

23. The spindle drive according to claim 15, wherein
the spindle thread (2a) has a crown circle surface (2b) and flanks (2c, 2d), and a first transition contour (7, 11) is arranged between the crown circle surface and the flanks of the spindle thread,
the nut thread (3a) has a root circle surface (3b) and flanks (3c, 3d), and a second transition contour (8, 12) is arranged between the root circle surface and the flanks of the nut thread, and
a circumferential gap (10, 13) is located between the first and the second transition contours (7, 8; 11, 12).

24. The spindle drive according to claim 23, wherein the first and the second transition contours have different radii (R, r).

25. The spindle drive according to claim 23, wherein the first and the second transition contours are chamfers (11, 12).

26. The spindle drive according to claim 15, wherein the spindle thread (2a, 22a) has cylindrical crown circle surfaces (2b) and the nut thread (3a, 23a) has cylindrical root circle surfaces (3b), and the crown circle surfaces (2b) and the root circle surfaces (3b) form corresponding sliding surfaces.

27. An actuator for a rear axle steering system, with a spindle drive (1, 21) comprising:
a spindle (2, 22) with a spindle thread (2a, 22a);
a spindle nut (3, 23) with a nut thread (3a, 23a);
the spindle thread (2a, 22a) and the nut thread (3a, 23a) forming a movement thread (4, 24) having a crown clearance (5, 25), a root clearance (6, 26) and a flank clearance (9), and
the spindle (2, 22) and the spindle nut (3, 23) being centered by at least one of a reduced crown clearance (5, 25) and a reduced root clearance (6, 26).

28. A rear axle steering system with an actuator with a spindle drive (1, 21) comprising:
a spindle (2, 22) with a spindle thread (2a, 22a), a spindle nut (3, 23) with a nut thread (3a, 23a), the spindle thread (2a, 22a) and the nut thread (3a, 23a) forming a movement thread (4, 24) having a crown clearance (5, 25), a root clearance (6, 26) and a flank clearance (9), and
the spindle (2, 22) and the spindle nut (3, 23) being centered by at least one of a reduced crown clearance (5, 25) and a reduced root clearance (6, 26).
